(19) United States
(12) Patent Application Publication
(10) Pub. No.: US 2016/0356063 A1
(43) Pub. Date: Dec. 8, 2016

(54) A Simple Mechanical Lock

(71) Applicant: YIFENG MANUFACTURING CO., LTD., Dongguan, Guangdong (CN)

(72) Inventor: Leo LAI, DONGGUAN City (CN)

(73) Assignee: Yifeng Manufacturing Co., Ltd., Guangdong (CN)

(21) Appl. No.: 14/915,588

(22) PCT Filed: Apr. 19, 2015
(86) PCT No.: PCT/CN2015/076931

§ 371 Date: Feb. 29, 2016

(30) Foreign Application Priority Data
Nov. 27, 2014 (CN) 201420723599.7

(51) Int. Cl. E05B 73/00; E05B 17/20

(52) U.S. Cl. CPC E05B 73/00; E05B 17/2011

(57) ABSTRACT

A simple mechanical lock comprises a lock shell and a lock rod. The lock shell has a lock part, a lock block and a lock core inside. One end of the lock rod is a lock hook, and the other end of the lock rod is provided with a locking device. The lock core is provided with a withstanding convex block, and said lock block is provided with an unlock groove for the insertion of said withstanding convex block to lock and unlock.

### FIELD OF THE INVENTION

The invention relates to the technical field of lockset, in particular to a simple mechanical lock.

### BACKGROUND OF THE INVENTION

The mechanical lock in the existing technology generally includes the password lock mechanism using password and the key lock mechanism using a key. This allows a mechanical lock to be unlocked in case of using a password or a key, thus facilitating the use of mechanical lock. However, the use of mechanical lock is limited by complex structure, high cost, large volume and heavy weight. For example, it is not suitable for use on small objects and is not easy to carry, and can not lock the lock anytime or anywhere. In a word, Its flexibility and mobility is poor.

### SUMMARY OF THE INVENTION

The purpose of the invention is to avoid the above problems in the existing technology and provide a simple mechanical lock with simple structure, low cost, small volume, light weight, and portability.

The purpose of the present invention is realized via the following technical solutions:

It provides a simple mechanical lock, which comprises a lock housing and a lock rod, said lock shell has lock part, lock block and lock core inside; One end of said lock rod is a lock hook, and the other end of said lock rod is provided with a locking device; The lock core is provided with a withstanding convex block, and said lock block is provided with an unlock groove for the insertion of said withstanding convex block; When the lock is to be locked, the withstanding convex block of lock core withstands the lock block, and the lock block withstands the lock part to make the lock part and the hook clamp; When the lock is to be unlocked, the lock core is turned to drive the withstanding convex block to rotate facing to the unlock groove. Then the withstanding convex block is inserted into the groove to depart the withstanding convex block and the lock block, and the lock block can move towards the lock core to which the lock block can release the withstanding of the lock part, and thus the lock part detaches from the lock hook.

Wherein a clutch block is arranged between said lock core and lock block, and said clutch block comprises a fixing part and a positioning column; Said withstanding convex block is arranged on said positioning column, said fixing part is clamped by said lock core and said lock core drives said clutch block to rotate; Said lock block is provided with a positioning hole for said positioning column to insert in, and said positioning column and said positioning hole can slide relatively.

Wherein a connecting column is arranged between said fixing part and said positioning column; Said lock shell also comprises a elastic sheet, one end of said elastic sheet is fixed on the lock shell and the other end of said elastic sheet clamps said connecting column.

Wherein said connecting column is set to a positive quadrangular while said elastic sheet is set to a U-shaped sheet, and the opening width of said U-shaped elastic sheet is equal to the width of said positive quadrangular.

Wherein a lock block spring is arranged between said lock block and clutch block; After the lock is unlocked, the lock block spring pushes the lock block towards said lock part to reset.

Wherein said lock block comprises a first withstanding incline and a second withstanding incline, said lock part comprises a first lock part and a second lock part; In the lock state, the first withstanding incline 43 withstands said first lock part to make the lock hook 22 clamp the first lock part, and the second withstanding incline 44 withstands said second lock part to make the lock hook 22 clamp the second lock part.

Wherein said first withstanding incline and second withstanding incline are arranged symmetrically about the center of said lock block.

Wherein said lock part is arranged as a round steel ball, and said lock hook is arranged as a groove which can be clamp-connected with the round ball. And locking device is provided as convenient hand-held spherical.

Wherein said lock shell comprises a bottom shell and a surface shell, and said bottom shell and surface shell can lock together.

The beneficial effect of the invention:

The invention of simple mechanical lock, the lock rod end with a lock hook is passed through the object which is to be locked and inserted into the lock hole of the lock core. Then the withstanding convex block of lock core withstands the top of the lock block, and the lock block withstands the lock part to make the lock part and the hook clamp, thus the lock is to be locked; The locking device has locking function as one end of the lock rod and is convenient for handhold; When the lock is to be unlocked, the lock core is turned to drive the withstanding convex block to rotate facing to the unlock groove. Then the withstanding convex block is inserted into the groove to depart the withstanding convex block and the lock block, and the lock block can move towards the lock core to which the lock block can release the withstanding of the lock part, and thus the lock part detaches from the lock hook. So that the lock rod can be pulled out from the lock shell to unlock the lock. Compared with the existing technology, the invention has simple structure, convenient assembly, low cost, and small volume, and it is easy to carry, flexible and can realize the lock of small objects anywhere and anytime.

### BRIEF DESCRIPTION OF THE DRAWINGS

Utilize drawings of the invention to make further explanation, but the embodiment in the drawings does not constitute any restrictions of the invention. For ordinary technical personnel in the field, he can also obtain other figures without creative labor according to the following drawings.

FIG. 1 is a structure sketch of the simple mechanical lock of the present invention.

FIG. 2 is a structure sketch of the simple mechanical lock of the present invention when the lock shell is hidden.

FIG. 3 is a structure sketch of the simple mechanical lock of the present invention with separated parts.

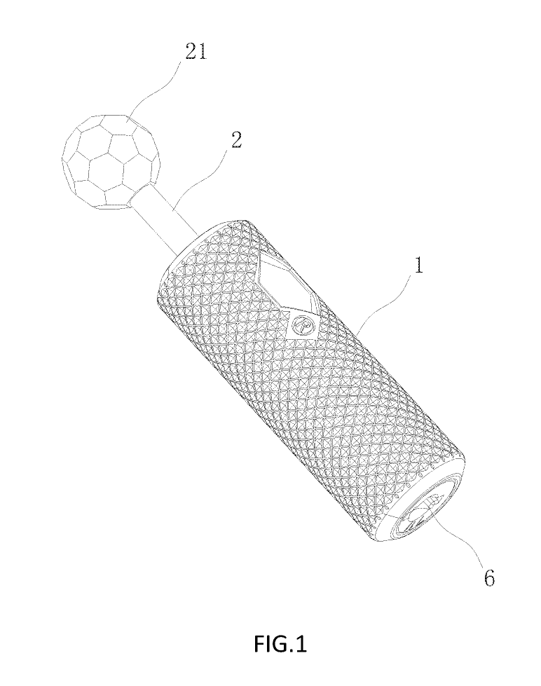

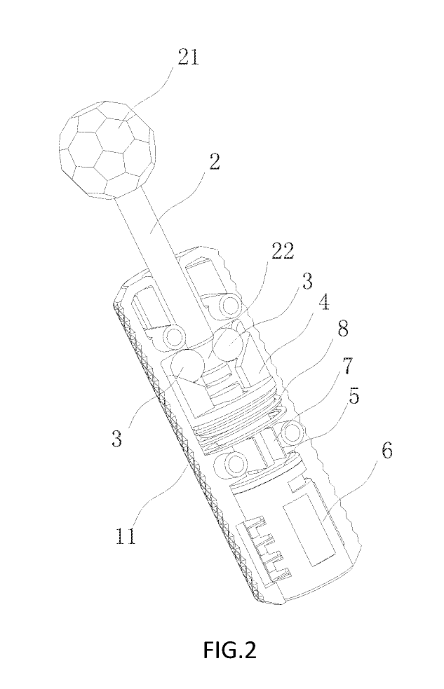

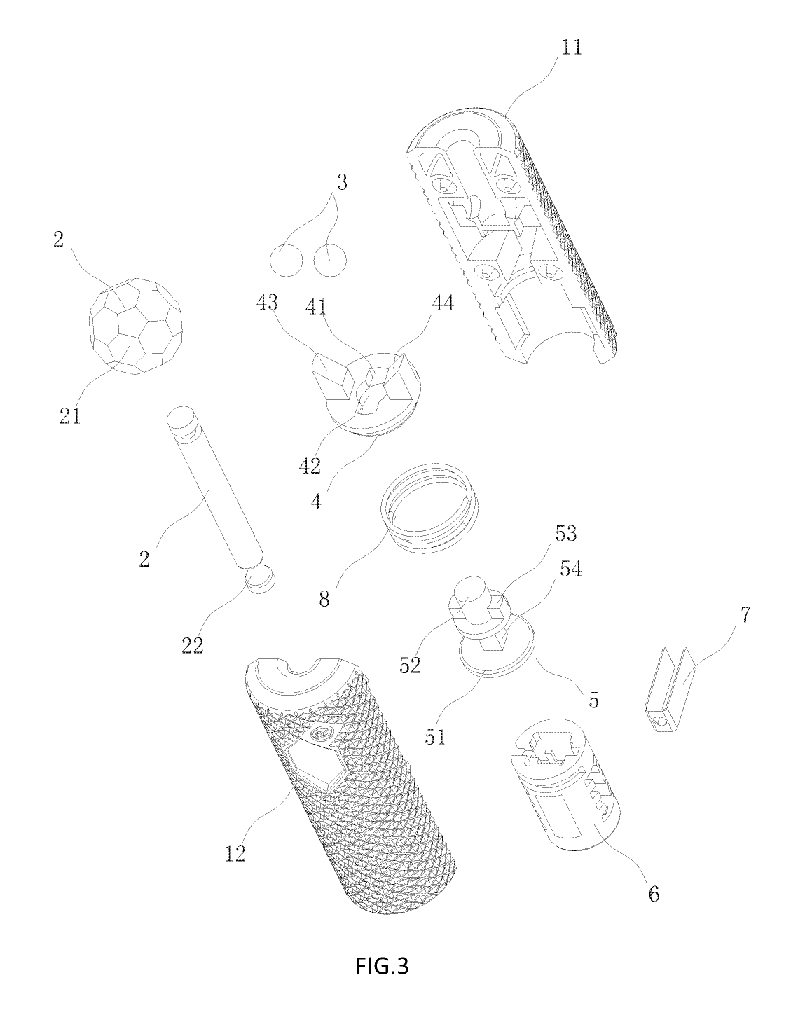

Drawing symbols in FIG. 1-FIG. 3
Lock shell 1, bottom shell 11, surface shell 12, Lock rod 2, locking device 21, lock hook 22, lock part 3, lock block 4, unlock groove 41, positioning hole 42, first withstanding incline 43, second withstanding incline 44, clutch block 5, fixing part 51, positioning column 52, withstanding convex block 53, connecting column 54, lock core 6, elastic sheet 7, and lock block spring 8.

### DESCRIPTION OF THE PREFERRED EMBODIMENTS

Now combine the followed embodiment to describe the invention further. The embodiment of a simple mechanical lock in this invention is shown in FIG. 1-FIG. 3, which comprises a lock shell 1 and a lock rod 2, lock shell 1 is orderly provided with a lock part 3, a lock block 4 and a lock core 6 from the top down inside it; One end of said lock rod 2 is a lock hook 22, and the other end of said lock rod 2 is provided with a locking device 21; locking device 21 is provided as convenient hand-held spherical, and has locking function as one end of the lock rod 2; It is also convenient to hold the locking device 21 to insert the lock rod 2 end with lock hook 22 into the keyhole of lock shell 1 to lock the lock.

The lock core 6 is provided with a withstanding convex block 53, and said lock block 4 is provided with an unlock groove 41 for the insertion of said withstanding convex block 53; When the lock is to be locked, insert the lock rod 2 end with lock hook 22 into the keyhole of lock shell 1, and the withstanding convex block 53 of lock core 6 withstands the lock block 4, thus the lock block 4 withstands the lock part 3 to make the lock part 3 move towards the keyhole and be clamped by the lock hook 22, then the lock is locked; When the lock is to be unlocked, the lock core 6 is turned to drive the withstanding convex block 53 to rotate facing to the unlock groove 41. Then the withstanding convex block 53 is inserted into the groove 41 to depart the withstanding convex block 53 and the lock block 4, and the lock block 4 can move towards the lock core 6 to which the lock block 4 can release the withstanding of the lock part 3, and thus the lock part 3 detaches from the lock hook 22. Then loch rod 2 can be pulled out from the keyhole of lock shell 1 to unlock the lock.

Because the simple mechanical lock of the invention can realize locking or unlocking only through motion control of lock part 3, lock block 4, lock core 6 and lock rod 2, it has simple structure, convenient assembly, low cost. And the lock rod 2 with locking device 21 is convenient for hand holding, which is convenient to the operation of high lock; In addition, the simple mechanical lock is small, easy to carry, flexible and can realize the lock of small objects anywhere and anytime.

Further, a clutch block 5 is arranged between said lock core 6 and lock block 4, and said clutch block 5 comprises a fixing part 51 and a positioning column 52; Said withstanding convex block 53 is arranged on said positioning column 52, said fixing part 51 is clamped by said lock core 6 and said lock core 6 drives said clutch block 5 to rotate through fixing part 51; Said lock block 4 is provided with a positioning hole 42 for said positioning column 52 to insert in, and said positioning column 52 and said positioning hole 42 can slide relatively. In the process of unlocking or locking, the reciprocating movement towards or away from the lock core 6 of lock block 4 is limited, and thus ensure that the lock core 6 motion is more stable and accurate.

Further, a connecting column 54 is arranged between said fixing part 51 and said positioning column 52; Said lock shell 1 also comprises a elastic sheet 7, one end of said elastic sheet 7 is fixed on the lock shell 1 and the other end of said elastic sheet 7 clamps said connecting column 54. During the lock core 6 drives the clutch block 5 to rotate, elastic sheet 7 can make the lock core 6 to rotate more smoothly. Preferably, said connecting column 54 is set to a positive quadrangular while said elastic sheet 7 is set to a U-shaped sheet, and the opening width of said U-shaped elastic sheet is equal to the width of said positive quadrangular. Positive quadrangular and U-shaped sheet not only has simple structure, convenient processing and assembly, they can also guarantee more accurate positioning of the clutch block 5 through their cooperation.

Again further, a lock block spring 8 is arranged between said lock block 4 and clutch block 5. One end of lock block spring 8 withstands and connects to said lock block 4, and the other end of lock block spring 8 withstands and connects to the limiting lug in lock shell 1. After the lock is unlocked, the lock rod 2 is pulled out of the keyhole in lock shell 1, then the lock block spring 8 pushes the lock block 4 towards said lock part 3 to reset. When the lock core 6 is turned again, lock core 6 drives withstanding convex block 53 to turn to withstand the lock block 4 through clutch block 5. Thus lock the lock again.

In this embodiment, said lock block 4 comprises a first withstanding incline 43 and a second withstanding incline 44, said lock part 3 comprises a first lock part and a second lock part.

In the lock state, the first withstanding incline 43 withstands said first lock part to make the lock hook 22 clamp the first lock part, and the second withstanding incline 44 withstands said second lock part to make the lock hook 22 clamp the second lock part. Lock hook 22 clamping two lock parts can increase the locking force of the lock rod 2, and then enhance the safety and security performance of the mechanical lock.

Further, said first withstanding incline 43 and second withstanding incline 44 are arranged symmetrically about the center of said lock block 4 to ensure the uniformity of the locking force in the lock state.

Further, said lock part 3 is arranged as a round steel ball, and said lock hook 22 is arranged as a groove which can be clamp-connected with the round ball. Round steel ball and groove clamp firmly and are not easy to wear. When unlocking the lock, the steel ball detaches from the groove easily.

In this embodiment, for convenient assembly of the mechanical lock, said lock shell 1 comprises a bottom shell 11 and a surface shell 12, and said bottom shell 11 and surface shell 12 can lock together. The outer surface of the lock shell 1 is provided with uneven friction surface, which is beautiful and convenient for carrying.

Finally, it should be explained that the above embodiment is only used to explain the technical scheme of the invention, rather than the limitation of the protection scope of the invention. Though detailed description of the present invention is made according to above embodiment, the general technical personnel in this field should understand that the technical proposal of the invention can be modified or has equivalent replacements, and not run out of the essence and scope of the technical solutions of this invention.

What is claimed is:

1. A simple mechanical lock, which comprises a lock shell and a lock rod, wherein said lock shell has a lock part, a lock block and a lock core inside; One end of said lock rod is a lock hook, and the other end of said lock rod is provided with a locking device; Said lock core is provided with a withstanding convex block, and said lock block is provided with an unlock groove for the insertion of said withstanding convex block; When the lock is to be locked, the withstanding convex block of lock core withstands the lock block, and the lock block withstands the lock part to make the lock part and the hook clamp; When the lock is to be unlocked, the lock core is turned to drive the withstanding convex block to rotate facing to the unlock groove, then the withstanding convex block is inserted into the unlock groove to depart the withstanding convex block and the lock block, and the lock block can move towards the lock core to which the lock block can release the withstanding of the lock part, and thus the lock part detaches from the lock hook.

2. The simple mechanical lock of claim 1, wherein a clutch block is arranged between said lock core and lock block, and said clutch block comprises a fixing part and a positioning column; Said withstanding convex block is arranged on said positioning column, said fixing part is clamped by said lock core and said lock core drives said clutch block to rotate; Said lock block is provided with a positioning hole for said positioning column to insert in, and said positioning column and said positioning hole can slide relatively.

3. The simple mechanical lock of claim 2, wherein a connecting column is arranged between said fixing part and said positioning column; Said lock shell also comprises a elastic sheet, one end of said elastic sheet is fixed on the lock shell and the other end of said elastic sheet clamps said connecting column.

4. The simple mechanical lock of claim 3, wherein said connecting column is set to a positive quadrangular while said elastic sheet is set to a U-shaped sheet, and the opening width of said U-shaped elastic sheet is equal to the width of said positive quadrangular.

5. The simple mechanical lock of claim 2, wherein a lock block spring is arranged between said lock block and clutch block; after the lock is unlocked, the lock block spring pushes the lock block towards said lock part to reset.

6. The simple mechanical lock of claim 1, wherein said lock block comprises a first withstanding incline and a second withstanding incline, said lock part comprises a first lock part and a second lock part; In the lock state, the first withstanding incline withstands said first lock part to make the lock hook clamp the first lock part, and the second withstanding incline 44 withstands said second lock part to make the lock hook clamp the second lock part.

7. The simple mechanical lock of claim 6, wherein said first withstanding incline and second withstanding incline are arranged symmetrically about the center of said lock block.

8. The simple mechanical lock of claim 1, wherein said lock part is arranged as a round steel ball, and said lock hook is arranged as a groove which can be clamp-connected with the round ball.

9. The simple mechanical lock of claim 1, wherein said locking device is set as a spherical part for easy handhold.

10. The simple mechanical lock of claim 1, wherein said lock shell comprises a bottom shell and a surface shell, and said bottom shell and surface shell can lock together.
